(19) United States
(12) Patent Application Publication
(10) Pub. No.: US 2026/0154129 A1
(43) Pub. Date: Jun. 4, 2026

(54) ADAPTIVELY OPTIMIZING PAGE SIZES FOR RESPONSES TO APPLICATION PROGRAMMING INTERFACE CALLS

(71) Applicant: AT&T Intellectual Property I, L.P., Atlanta, GA (US)

(72) Inventor: Barrett Kreiner, Woodstock, GA (US)

(21) Appl. No.: 18/966,108

(22) Filed: Dec. 2, 2024

(51) Int. Cl. G06F 9/54; G06F 11/34; G06Q 10/0633

(52) U.S. Cl. CPC G06F 9/54; G06F 11/3409; G06Q 10/0633

(57) ABSTRACT

An example method includes issuing a first application programming interface call to request a portion of data from a system of records, receiving, from the system of records, a response to the first application programming interface call, calculating a set of performance metrics for the system of records, based on at least one parameter of the response to the first application programming interface call, calculating, based on the set of performance metrics, a page size for responses to be issued for subsequent application programming interface calls to be issued to retrieve an entirety of the data, issuing the subsequent application programming interface calls to the system of records, receiving, from the system of records, responses to the subsequent application programming interface calls, and assembling the entirety of the data from the response to the first application programming interface call and the responses to the subsequent application programming interface calls.

The present disclosure relates generally to application programming interfaces, and relates more particularly to devices, non-transitory computer-readable media, and methods for adaptively optimizing page sizes for responses to application programming interface calls.

### BACKGROUND

Application programming interfaces (APIs) provide software interfaces between computers and/or computer programs. An API may comprise multiple parts which act as tools or services that are available to a computer programmer. A program or a programmer that uses one of these parts is said to call that portion of the API. The calls that make up the API may also be referred to as subroutines, methods, requests, or endpoints.

### SUMMARY

Devices, non-transitory computer-readable media, and methods for adaptively optimizing page sizes for responses to application programming interface calls are disclosed. An example method includes issuing a first application programming interface call to request a portion of data from a system of records, receiving, from the system of records, a response to the first application programming interface call, calculating a set of performance metrics for the system of records, based on at least one parameter of the response to the first application programming interface call, calculating, based on the set of performance metrics, a page size for responses to be issued for subsequent application programming interface calls to be issued to retrieve an entirety of the data, issuing the subsequent application programming interface calls to the system of records, receiving, from the system of records, responses to the subsequent application programming interface calls, and assembling the entirety of the data from the response to the first application programming interface call and the responses to the subsequent application programming interface calls.

In another example, a non-transitory computer-readable medium stores instructions which, when executed by a processing system including at least one processor, cause the processing system to perform operations. The operations include issuing a first application programming interface call to request a portion of data from a system of records, receiving, from the system of records, a response to the first application programming interface call, calculating a set of performance metrics for the system of records, based on at least one parameter of the response to the first application programming interface call, calculating, based on the set of performance metrics, a page size for responses to be issued for subsequent application programming interface calls to be issued to retrieve an entirety of the data, issuing the subsequent application programming interface calls to the system of records, receiving, from the system of records, responses to the subsequent application programming interface calls, and assembling the entirety of the data from the response to the first application programming interface call and the responses to the subsequent application programming interface calls.

In another example, a device includes a processing system including at least one processor and a non-transitory computer-readable medium. The non-transitory computer-readable medium stores instructions which, when executed by the processing system, cause the processing system to perform operations. The operations include issuing a first application programming interface call to request a portion of data from a system of records, receiving, from the system of records, a response to the first application programming interface call, calculating a set of performance metrics for the system of records, based on at least one parameter of the response to the first application programming interface call, calculating, based on the set of performance metrics, a page size for responses to be issued for subsequent application programming interface calls to be issued to retrieve an entirety of the data, issuing the subsequent application programming interface calls to the system of records, receiving, from the system of records, responses to the subsequent application programming interface calls, and assembling the entirety of the data from the response to the first application programming interface call and the responses to the subsequent application programming interface calls.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for adaptively optimizing page sizes for responses to application programming interface calls may operate;

FIG. 2 illustrates a flowchart of an example method for adaptively optimizing page sizes for responses to application programming interface calls, in accordance with the present disclosure;

FIG. 3 illustrates an example table that may be retrieved according to examples of the present disclosure for adaptively optimizing page sizes for responses to application programming interface calls; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for adaptively optimizing page sizes for responses to application programming interface calls. As discussed above, APIs provide software interfaces between computers and/or computer programs. An API may comprise multiple parts which act as tools or services that are available to a computer programmer. A program or a programmer that uses one of these parts is said to call that portion of the API. The calls that make up the API may also be referred to as subroutines, methods, requests, or endpoints.

Many large-scale platforms, such as cloud computing platforms that manage digital workflows for enterprise operations, inherently impose limitations on API access. For instance, a platform may limit the number of wall seconds for which an API will be allowed to run, the number of rows of data that an API can request from the platform, a size of a payload delivered to an API, and the like. The activity load of a platform may also impact the performance of various API calls. As a result, when an API attempts to pull data from a large-scale platform, most platforms (especially platforms that maintain data in tabular form) will offer API transactions as paged data. This allows the API to request data from a table by specifying an offset in the table at which to start providing results and a maximum length (e.g., number of rows) of the results.

For instance, an initial API call requesting data will establish a context for the request, including the source of the requested data (e.g., the table containing the requested data), the query (e.g., the data being requested), and the fields (e.g., of the table) to be returned in response to the request. The initial API call will also typically include the total number of records (e.g., rows) that match the initial records requested. The requested data can then be accessed within the same transactional context using an offset and a number of records. However, extraction of data from tables in excess of one million rows may take several hours to complete.

For example, if an API call asks for a specified table that contains five thousand rows, and the initial number of rows requested is one thousand, then a response to the API call may include the following information: (1) an indication that the table contains five thousand rows; (2) a transaction identifier for the results of the request, and, in theory, the first one thousand rows of the specified table. Subsequent API calls with the same transaction identifier and different offsets and lengths should ideally retrieve the “pages” of the results. For instance, a first API call with an offset equal to zero and a length of one thousand should return the first one thousand rows of the specified table. A second API call with the same transaction identifier as the first API call and with an offset equal to one thousand and a length of one thousand should return the second one thousand rows of the specified table; a third API call with the same transaction identifier as the first and second API calls and with an offset equal to two thousand and a length of one thousand should return the third one thousand rows of the specified table; a fourth API call with the same transaction identifier as the first, second, and third API calls and with an offset equal to three thousand and a length of one thousand should return the fourth one thousand rows of the specified table; and a fifth API call with the same transaction identifier as the first, second, third, and fourth API calls and with an offset equal to four thousand and a length of one thousand should return the fifth one thousand rows of the specified table. These five API calls will collectively retrieve the entire table.

Since transactional results are guaranteed to be stable for the life of a transaction, there is typically no limitation to prevent multiple, concurrent requests for different pages of data from being issued in parallel (rather than one at a time in a serial fashion). However, choosing the optimal page size (i.e., the length of the returned result, or number of records returned in the above example) typically requires a lot of a prior knowledge about the size of the dataset (e.g., table), how much time is needed to fully respond to each request for data, and how many fields are returned. Too small a page size (e.g., potentially as small as one API call per row) may result in poor performance due to the overhead (e.g., authentication, compute, compress, network latency, and the like) for multiple API calls, negatively impacting both platform performance and client performance. Too large a page size, and the platform may be unable to provide a complete response to an API call due to resource limits being exceeded, necessitating the issuance of additional API calls (hereinafter referred to as “supplemental API calls”) which, as discussed above, will increase the overhead.

Moreover, even though a “good” page size can be estimated before submitting an API call, other tasks or workloads on the platform may cause nondeterministic variability in the performance of the API. For instance, an API call requesting one thousand records may take forty seconds to fulfill. However, before the next API call is issued to request the next one thousand rows, a background job may begin on the platform, and concurrent execution of the background job may cause the next API call to take fifty seconds to fulfill. As additional jobs are started on the platform, subsequent API calls may take sixty seconds or longer to fulfill and may contain errors.

For instance, when a limit is reached, a given API call may return no data, or, if the API does return data, the returned data may be incomplete. As an example, a request for data with an offset equal to one thousand and a length equal to one thousand may return only nine hundred rows, and it will be up to the calling program to recognize that the returned data is incomplete. The data may be completed by issuing a supplemental API call with an offset equal to nine hundred and a length equal to one hundred to retrieve the data that was omitted from the response to the initial request. However, the supplemental API call increases the overhead of the transaction. An optimal page size should be capable of resulting in the return of a complete data set in the fewest requests possible.

Examples of the present disclosure are directed to the optimization of API calls for APIs that are used to import and export data from tables. In particular, examples of the present disclosure optimize the page size for API data requests by issuing an initial API call to a platform to request a portion of data stored by the platform, and subsequently computing a plurality of performance characteristics from the platform's response to the request. Subsequent API calls issued to the platform may include the optimized page size that is calculated from the performance characteristics. The optimized page count may allow the subsequent API calls to retrieve the remaining portion of the data stored by the platform in the fastest manner that can be reasonably expected to be fulfilled by the platform.

Further examples of the present disclosure may issue the subsequent API calls to the platform in parallel, where each of the subsequent API calls requests a different remaining portion of the data stored by the platform (e.g., specified by an offset). Issuing the subsequent API calls in parallel rather than in series may allow the subsequent API calls to retrieve the remaining portion of the data stored by the platform even faster. In even further examples, rather than utilizing the optimized page count when the subsequent API calls are issued in parallel, the remaining portion of the data may be split into equal portions across the subsequent API calls (even if this results in the page counts of the subsequent API requests being smaller than the optimized page count). This may reduce the amount of time needed to complete each of the subsequent API calls (since fewer records are potentially being requested in each of the subsequent API calls).

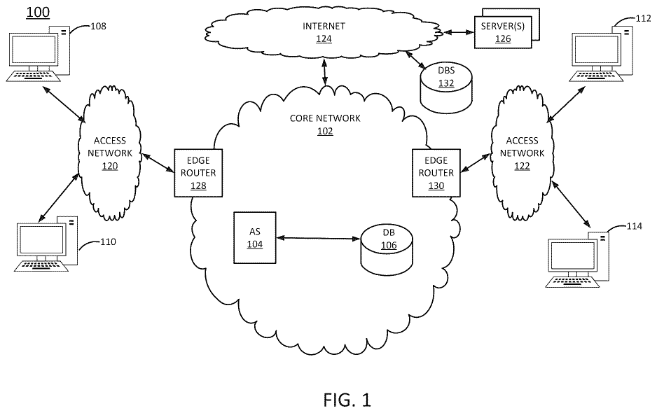

Thus, examples of the present disclosure may significantly reduce the amount of time needed to extract data stored by a system of records via strategic planning of API calls, rather than by purchasing additional compute and memory resources and therefore driving up the costs of the extraction. High-volume interactions with systems of records can be supported without sacrificing the timeliness of the system response times. Although examples of the present disclosure are described below within the context of data or table reads, it will be appreciated that a similar approach may be applied to data or table writes. These and other aspects of the present disclosure are discussed in greater detail below in connection with the examples of FIGS. 1-4.

To further aid in understanding the present disclosure, FIG. 1 illustrates an example system 100 in which examples of the present disclosure for adaptively optimizing page sizes for responses to application programming interface calls may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with one or more user endpoint devices 108 and 110. The access network 120 may transmit and receive communications between the user endpoint devices 108 and 110, between the user endpoint devices 108 and 110 and the server(s) 126, the AS 104, other components of the core network 102, devices reachable via the Internet in general, and so forth. Similarly, the access network 122 may be in communication with one or more user endpoint devices 112 and 114. The access network 122 may transmit and receive communications between the user endpoint devices 112 and 114, between the user endpoint devices 112 and 114 and the server(s) 126, the AS 104, other components of the core network 102, devices reachable via the Internet in general, and so forth.

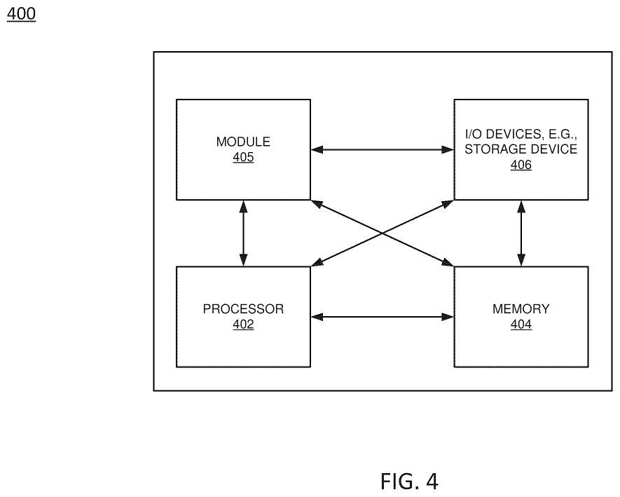

In one example, each of the user endpoint devices 108-114 may comprise any single device or combination of devices that may be used to submit requests to the application server 104 related to accessing data stored in a system of records. For example, any of the user endpoint devices 108-114 may comprise a mobile device, a cellular smart phone, a gaming console, an extended reality device, a set top box, a laptop computer, a tablet computer, a desktop computer, an Internet of Things (IoT) device, a wearable smart device (e.g., a smart watch, a fitness tracker, a head mounted display, or Internet-connected glasses), a sensor, and autonomous vehicle (e.g., drone, self-driving automobile, etc.), an application server, a bank or cluster of such devices, and the like. To this end, the user endpoint devices 108-114 may comprise one or more physical devices, e.g., one or more computing systems or servers, such as computing system 400 depicted in FIG. 4, and may be configured as described below.

In one example, one or more servers 126 may be accessible to the user endpoint devices 108-114 via the Internet 124 in general. In one example, the server(s) 126 may comprise systems of records (e.g., cloud computing platforms that manage digital workflows for enterprise operations or other types of systems of records). Data in the form of records (e.g., tables or other data structures) may be stored in DBs 132 that are accessible by the server(s) 126 and/or by the AS 104. The server(s) 126 may operate in a manner similar to the AS 104, which is described in further detail below.

In accordance with the present disclosure, the AS 104 and DB 106 may be configured to provide one or more operations or functions in connection with examples of the present disclosure for adaptively optimizing page sizes for responses to application programming interface calls, as described herein. For instance, the AS 104 may be configured to determine an optimal page size for API calls to a system of records (e.g., a server 126 or another system of records) to retrieve data, where the optimal page size is determined to maximize a number of records returned per API call while minimizing a likelihood of exceeding a resource limit of the system of records. The AS 104 may also determine an optimal number of API calls to be issued to the system of records to retrieve the data in its entirety and plan whether the optimal number of API calls should be issued in a serial or parallel fashion.

To this end, the AS 104 may comprise one or more physical devices, e.g., one or more computing systems or servers, such as computing system 400 depicted in FIG. 4, and may be configured as described below. The AS 104 may have access to at least one database (DB) 106, where the DB 106 may store page sizes, numbers of API calls, and other data for specific data access transactions performed by the AS 104.

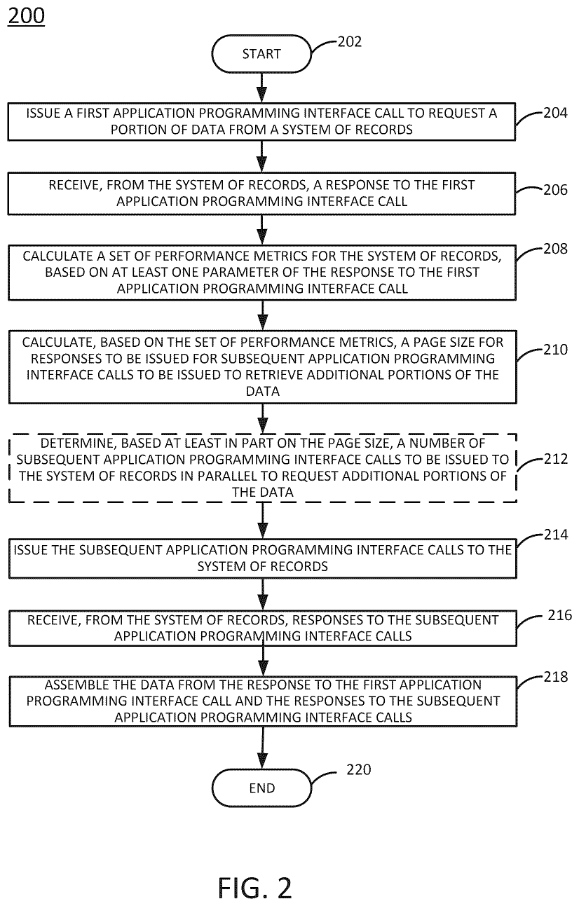

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for adaptively optimizing page sizes for responses to application programming interface calls, as described herein. One example method for adaptively optimizing page sizes for responses to application programming interface calls is described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, user endpoint devices 108-114 may communicate with the core network 102 via different access networks. Thus, these and other modifications are all contemplated within the scope of the present disclosure.

FIG. 2 illustrates a flowchart of an example method 200 for adaptively optimizing page sizes for responses to application programming interface calls, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processing system 402.

The method 200 begins in step 202 and proceeds to step 204. In step 204, the processing system may issue a first application programming interface call to request a portion of data from a system of records.

In one example, the system of records may comprise a large-scale computing platform, such as a cloud computing platform that manages digital workflows for enterprise operations. The system of records may store data in one or more databases, and, in one example, the data (e.g., subscriber data records, call detail records, root cause analysis data records for network failures, etc.) may be stored in the form of tables. In one example, the first API call may request a portion of the data that is stored in one of these tables. In one example, the portion of the data may comprise less than an entirety of the data stored in the table (e.g., a subset of the rows contained in the table); however, in other examples, the portion of the data may comprise the entirety of the data (e.g., all of the rows contained in the table).

In one example, the first API call may specify a source of the data that is requested (e.g., a specific table in a database), fields of the source to be returned in response to the first API call, and a length (e.g., number of rows) of the data that is requested. The length of the data that is requested may comprise a defined number of records (e.g., one thousand rows) or a request to return as much of the data as possible until the system of records reaches a limit. Since the first API call may not be preceded by any other API calls to the system of records, the first API call may include an offset that is equal to zero, or may include no offset at all.

In step 206, the processing system may receive, from the system of records, a response to the first application programming interface call. In one example, the response to the first API call may include at least some of the data that was requested by the first API call. For instance, in some cases, the response to the first API call may include all of the data that was requested by the first API call. However, in another example, the response to the first API call may include less than all of the data that was requested by the first API call. For instance, if the first API call included a length of one thousand rows, the response to the first API call may include only nine hundred rows. It should be noted that if the first API call requested a defined number of records (e.g., one thousand rows), the estimated RPS may be less accurate than if the first API call requested as much of the data as possible until the system of records reaches a limit.

In step 208, the processing system may calculate a set of performance metrics for the system of records, based on parameters (e.g., one or more parameters) of the response to the first application programming interface call. In one example, the set of performance metrics includes at least one of: an estimated records per second (RPS) that the system of records can currently deliver via the API, an estimated maximum number of records per request, a remaining number of records of the data, or an estimated amount of time required to retrieve a remainder of the data (i.e., any portion of the data not returned in the response to the first API call).

In one example, the estimated RPS may be calculated by measuring the amount of time elapsed between the issuance of the first API call and the receipt of the response to the first API call. The number of records returned in the response to the first API call may then be divided by the amount of time elapsed between the issuance of the first API call and the receipt of the response to the first API call to estimate the RPS.

In one example, the estimated maximum number of records per request may be calculated by multiplying the estimated RPS by a timeout of the API. In one example, the timeout of the API represents a maximum amount of time for which the API will execute to attempt to fulfill a request (e.g., in one example, approximately sixty wall seconds). If the request cannot be fulfilled within that maximum amount of time, the API will terminate with either no results or incomplete results. Due to the ebb and flow of the system of records, it is likely that some API calls may exceed the time limit of the API and result in the need for a supplemental API call to be issued to retrieve any remaining data that a preceding API call failed to return. However, as discussed above, it is typically undesirable to issue these supplemental API calls since the overhead of a transaction increases with the number of API calls needed to complete the transaction.

In one example, the processing system may seek to minimize the number of supplemental API calls that are needed by reducing a maximum number of API calls to factor in a time buffer. The time buffer may assume that the system of records will not always be able to fulfill an API call in the amount of time indicated by the timeout (e.g., due to variability on the system of records caused by other jobs, for instance). For instance, if the timeout is sixty seconds, applying a ten-second time buffer may result in an estimate of fifty seconds for the fulfillment of subsequent API requests. This time buffer may form the basis for a single-threaded optimal page sizing for the first API call as configured. The optimal page sizing is configured to return the maximum possible number of records per API call while minimizing the likelihood that an API call will exceed a resource limit and require a supplemental API call.

In one example, the remaining number of records of the data may be calculated by subtracting a number of records returned in the response to the first API call from the total number of records contained in the data.

In one example, the estimated amount of time required to retrieve the remainder of the data may be calculated by dividing the remaining number of records by the RPS.

In step 210, the processing system may calculate, based on the set of performance metrics, a page size for responses to be issued for subsequent application programming interface calls to be issued to retrieve additional portions of the data. In one example, the additional portions of the data may, collectively with the portion of the data received in step 206, comprise the data in its entirety. That is, the first API call and the subsequent API call may be configured to retrieve the data in its entirety. However, in other examples, the data may not be needed in its entirety. In this case, the additional portions of the data may, collectively with the portion of the data received in step 206, comprise the data in less than its entirety.

In one example, an optimal page size for the subsequent API calls may be calculated based on at least one of: the RPS, the estimated maximum number of records per request, and the buffer time.

For instance, if the data being requested from the system of records is a table containing five thousand rows, and five hundred rows were returned in 41.66 seconds in response to the first API call, then the RPS would equal to twelve (500/41.66). With an API timeout of sixty seconds, the estimated maximum number of rows per request would be 720 (12×60). With ten seconds of buffer time being factored in, the optimal page size would be estimated to be six hundred (12×(60−10)).

In optional step 212 (illustrated in phantom), the processing system may determine, based at least in part on the page size, a number of subsequent application programming interface calls to be issued to the system of records in parallel to request additional portions of the data.

As discussed above, multiple API calls can be issued to the system of records in parallel, where each API call of the multiple API calls requests a different page of the result set (e.g., requests a portion of the data starting from a different offset). If multiple API calls are issued in parallel, each API call of the multiple API calls can request a page of the size calculated in step 210. However, for shorter data sets, requesting pages of the size calculated in step 210 would likely result in fewer parallel API calls being issued, which fails to maximize the value of utilizing parallel threads.

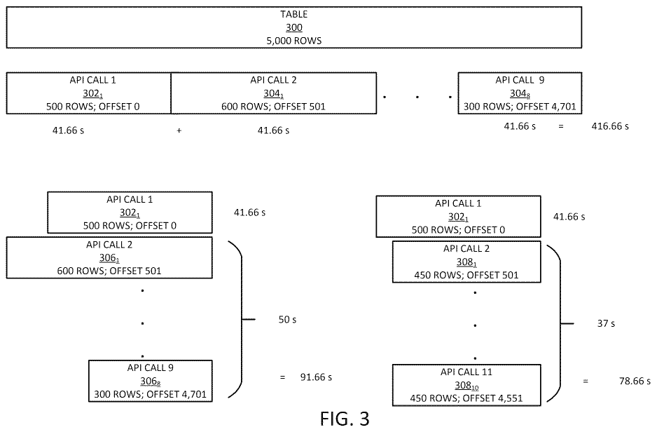

FIG. 3 illustrates an example table 300 that may be retrieved according to examples of the present disclosure for adaptively optimizing page sizes for responses to application programming interface calls. In particular, the table 300 is the example table discussed above, which includes five thousand rows.

Referring to FIG. 3 and continuing the example above in which the optimal page size is calculated to be estimated to be six hundred rows, with 4,500 rows remaining to be retrieved after the first API call 302₁, it would take approximately 416.66 seconds (e.g., just under seven minutes) to load the entire table if eight subsequent API calls 304₁-304₈ (each having a page size of 600 rows) are issued in a serial (one at a time) manner. The estimate of 416.66 seconds includes the 41.66 seconds taken to complete the first API call 302₁ plus an additional 375 seconds (4,500/12) to complete the subsequent API calls 304₁-304₈.

However, if the subsequent API calls were issued as eight parallel API calls 306₁-306₈ (still having a page size of six hundred rows), and each of these eight subsequent API calls 306₁-306₈ would take approximately fifty seconds (600/12) to complete. The parallel issuance of the subsequent API calls 306₁-306₈ would take approximately 91.66 seconds (1 minute, 31.66 seconds) to load the entire table. The estimate of 91.66 seconds includes the 41.66 seconds taken to complete the first API call 302₁ plus an additional fifty seconds to complete the subsequent API calls 306₁-306₈.

In a further example, the parallel issuance of the subsequent API calls could be further optimized by dividing the 4,500 remaining rows of the table equally among the subsequent API calls 308₁-308₁₀. In the parallel API calls example above, the eighth subsequent API call 306₈ would retrieve only three hundred rows to complete the table (since the other seven subsequent API calls 306₁-306₇ would collectively retrieve 600×7=4,200 rows of the 4,500 remaining rows). If the 4,500 remaining rows were divided equally among ten subsequent API calls 308₁-308₁₀ (assuming that ten is the maximum number of parallel API calls that the system of records will allow), then each subsequent API call 308₁-308₁₀ would return 450(4,500/10 ) rows and take thirty-seven (450/12) seconds to complete. Thus, issuing ten subsequent API calls 308₁-308₁₀ with the smaller page size (450 versus 600) would take approximately 78.66 seconds (1 minute, 18.66 seconds) to load the entire table. The estimate of 78.66 seconds includes the 41.66 seconds taken to complete the first API call 302₁ plus an additional thirty-seven seconds to complete the subsequent API calls 308₁-308₁₀.

It should be noted that splitting the remaining rows of the table equally among the maximum permitted number of parallel API calls has its limits. The page size for the parallel API calls should not be so low that the overhead of the API calls is greater than the cost savings. For instance, ten parallel API calls that each requests one record would require significantly more overhead than a single API call that requests ten records, and the cost saving would likely be minimal. Thus, in some examples, a floor value may be imposed to prevent the page size of the subsequent API calls from being too small, even if larger pages sizes means that fewer API calls will be issued in parallel.

In step 214, the processing system may issue the subsequent application programming interface call(s) (e.g., one or more subsequent API calls) to the system of records. In one example, the one or more subsequent API calls are issued in the manner determined according to steps 210 and/or 212. For instance, in one example, the subsequent API calls may comprise a plurality of subsequent API calls issued in series (e.g., one at a time), where each subsequent API call of the plurality of subsequent API calls includes the page size that is calculated in step 210. In another example, the subsequent API calls may comprise a plurality of subsequent API calls issued in parallel, where each or most of the subsequent API calls of the plurality of subsequent API calls includes the page size that is calculated in step 210. In another example, the subsequent API calls may comprise a plurality of subsequent API calls issued in parallel, where each subsequent API call of the plurality of subsequent API calls includes a page size that is smaller than the page size calculated in step 210 to maximize the number of the plurality of subsequent API calls.

Moreover, step 210 and/or step 212 may include determining offsets for the subsequent API calls so that any data returned in response to the subsequent API calls does not overlap. These offsets may be included in the subsequent API calls when the subsequent API calls are issued to the system of records in step 214.

In step 216, the processing system may receive, from the system of records, responses to the subsequent application programming interface calls. In one example, each of the responses to the subsequent API calls may include at least some of the data that was requested by the subsequent API calls. Moreover, each of the responses to the subsequent API calls should contain a different portion of the data stored by the system of records. In one example, there will be no overlap between the portions of the data contained in the responses to the subsequent API calls.

In step 218, the processing system may assemble the data from the response to the first application programming interface call and the responses to the subsequent application programming interface calls. In one example, if the response to the first API call and the responses to the subsequent API calls all contain all of the data requested in the first API call and the subsequent API calls, then the processing system will have all of the data needed to reconstruct the desired portion of the data (e.g., the data in its entirety, or a desired subset of the data). Any offsets specified in the first API call and the subsequent API calls may be used to ensure that the individual portions of the data are assembled in the correct order or arrangement (e.g., such that the data assembled by the processing system matches the data stored in the system of records). The method may end in step 220.

Thus, examples of the present disclosure may significantly reduce the amount of time needed to extract data stored by a system of records via strategic planning of API calls, rather than by purchasing additional compute and memory resources and therefore driving up the costs of the extraction. High-volume interactions with systems of records can be supported without sacrificing the timeliness of the system response times.

In one example, if the page size that results from dividing the remaining rows of the table equally among the subsequent API calls exceeds the previously computed optimal page size (e.g., as computed in step 210), then a simple comparison may be computed. In the above example, the calculations are relatively simple, but the result of dividing the remaining rows of the table equally among ten subsequent API calls issued in parallel results in an almost eighty percent reduction in the overall time required to complete the table load (i.e., 78.66 seconds versus 416.66 seconds). For relatively small tables, the disclosed approach may result in minutes being saved; for relatively large tables, the disclosed approach may result in hours being saved.

Similar techniques can be utilized for other transactions that rely on API calls, including writing data. However, in the case of writing data, it is not the number of records or time being manipulated to optimize the transaction, but the size of the outbound payload. Similar processing efforts allow for the pushing of data into large systems of records in parallel while waiting for the systems of records to provide acknowledgement of the payloads and of the processing by the systems of records.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for adaptively optimizing page sizes for responses to application programming interface calls, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for adaptively optimizing page sizes for responses to application programming interface calls (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for adaptively optimizing page sizes for responses to application programming interface calls (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
issuing, by a processing system including at least one processor, a first application programming interface call to request a portion of data from a system of records;
receiving, by the processing system from the system of records, a response to the first application programming interface call;
calculating, by the processing system, a set of performance metrics for the system of records, based on at least parameter of the response to the first application programming interface call;
calculating, by the processing system based on the set of performance metrics, a page size for responses to be issued for subsequent application programming interface calls to be issued to retrieve an entirety of the data;
issuing, by the processing system, the subsequent application programming interface calls to the system of records;
receiving, by the processing system from the system of records, responses to the subsequent application programming interface calls; and
assembling, by the processing system, the entirety of the data from the response to the first application programming interface call and the responses to the subsequent application programming interface calls.

2. The method of claim 1, wherein the system of records comprises a cloud computing platform that manages digital workflows for enterprise operations.

3. The method of claim 1, wherein the system of records stores the data in a tabular form.

4. The method of claim 1, wherein the portion of the data comprises less than the entirety of the data.

5. The method of claim 1, wherein the first application programming interface call specifies a source of the data, fields of the source to be returned in response to the first application programming interface call, and a length of the data that is requested.

6. The method of claim 5, wherein the length of the data comprises a number of records.

7. The method of claim 5, wherein the length of the data comprises a defined length.

8. The method of claim 5, wherein the length of the data comprises as much of the data as the system of records is able to return before reaching a limit.

9. The method of claim 1, wherein the set of performance metrics includes at least one of: an estimated records per second that the system of records is able to currently deliver via an application programming interface from which the first application programming interface call is issued, an estimated maximum number of records that the system of records is able to return per request, a remaining number of records of the data not including any portion of the data included in the response to the first application programming interface call, or an estimated amount of time required to retrieve the remaining number of records.

10. The method of claim 9, wherein the estimated records per second is calculated by dividing a number of records included in the response to the first application programming interface call by an amount of time elapsed between the issuing of the first application programming interface call and the receiving of the response to the first application programming interface.

11. The method of claim 9, wherein the estimated maximum number of records that the system of records is able to return per request is calculated by multiplying the estimated records per second by a timeout of the application programming interface.

12. The method of claim 9, wherein the estimated amount of time required to retrieve the remaining number of records is calculated by dividing the remaining number of records by the estimated records per second.

13. The method of claim 1, wherein the page size is calculated to be configured to return a maximum possible amount of a remainder of the data not returned in the response to the first application programming interface call per each application programming interface call of the subsequent application programming interface calls while minimizing a likelihood that an application programming interface call of the subsequent application programming interface calls will exceed a resource limit of the system of records.

14. The method of claim 1, wherein the subsequent application programming interface calls are issued in a parallel manner to the system of records.

15. The method of claim 14, wherein each application programming interface call of the subsequent application programming interface calls includes a different offset to specify a location in the data at which the system of records will begin returning data.

16. The method of claim 14, further comprising:
determining a number of the subsequent application programming interface calls to be issued in the parallel manner to the system of records.

17. The method of claim 16, wherein the number is determined to be a maximum number of parallel application programming interface calls that is supported by the system of records.

18. The method of claim 17, wherein the page size is reduced so that each response of the responses to the subsequent application programming interface calls contains an equal amount of the data.

19. A non-transitory computer-readable medium storing instructions which, when executed by a processing system including at least one processor, cause the processing system to perform operations, the operations comprising:
issuing a first application programming interface call to request a portion of data from a system of records;
receiving, from the system of records, a response to the first application programming interface call;
calculating a set of performance metrics for the system of records, based on at least one parameter of the response to the first application programming interface call;
calculating, based on the set of performance metrics, a page size for responses to be issued for subsequent application programming interface calls to be issued to retrieve an entirety of the data;
issuing the subsequent application programming interface calls to the system of records;
receiving, from the system of records, responses to the subsequent application programming interface calls; and
assembling the entirety of the data from the response to the first application programming interface call and the responses to the subsequent application programming interface calls.

20. A device comprising:
a processing system including at least one processor; and
a non-transitory computer-readable medium storing instructions which, when executed by the processing system, cause the processing system to perform operations, the operations comprising:
issuing a first application programming interface call to request a portion of data from a system of records;
receiving, from the system of records, a response to the first application programming interface call;
calculating a set of performance metrics for the system of records, based on at least one parameter of the response to the first application programming interface call;
calculating, based on the set of performance metrics, a page size for responses to be issued for subsequent application programming interface calls to be issued to retrieve an entirety of the data;
issuing the subsequent application programming interface calls to the system of records;
receiving, from the system of records, responses to the subsequent application programming interface calls; and
assembling the entirety of the data from the response to the first application programming interface call and the responses to the subsequent application programming interface calls.
